(19) United States
(12) Patent Application Publication
(10) Pub. No.: US 2016/0028738 A1
(43) Pub. Date: Jan. 28, 2016

(54) VALIDITY VERIFICATION METHOD AND INTERMEDIATE SERVER

(71) Applicant: Tencent Technology (Shenzhen) Company Limited, Shenzhen (CN)

(72) Inventor: Dongyu Xie, Shenzhen (CN)

(73) Assignee: Tencent Technology (Shenzhen) Company Limited, Shenzhen (CN)

(21) Appl. No.: 14/641,602

(22) Filed: Mar. 9, 2015

Related U.S. Application Data
(63) Continuation of application No. PCT/CN2014/081730, filed on Jul. 7, 2014.

(30) Foreign Application Priority Data
Dec. 16, 2013 (CN) 201310693060.1

(51) Int. Cl. H04L 29/06

(52) U.S. Cl. CPC H04L 63/104; H04L 63/123

(57) ABSTRACT

A validity verification method and an intermediate server are provided. The method through the intermediate server includes receiving a request from one or more external platforms for accessing an operation server; connecting the one or more external platforms with the operation server; verifying validity of the request according to an external platform and an operation which the external platform is one of the one or more external platforms and identifies where the request is from, and the operation is requested to be accessed by the external platform; and after the request is verified, sending the request to the operation server.

### CROSS-REFERENCE TO RELATED APPLICATIONS

This application is a continuation of International Application No. PCT/CN2014/081730, filed on Jul. 7, 2014, which claims priority to Chinese Patent Application No. 201310693060.1, filed on Dec. 16, 2013, the entireties of both of which are hereby incorporated by reference.

### FIELD OF THE TECHNOLOGY

The present disclosure relates to information security field, and more particularly to a validity verification method and an intermediate server.

### BACKGROUND OF THE TECHNOLOGY

In related technology, the operation server and external platform are in joint management, and validity verifications of the external platforms are performed by the operation servers. However, such a verification manner may bring some problems. For example, under a computer gaming environment, when a game provider and a platform are in joint management, interface, key and encryption are used commonly. Particularly, the game provider supplies the interface to the cooperation party, and then cooperation party encrypts the interface parameter with a key, subsequently the game provider will verify the cryptograph to authorize the cooperation party to access. For different platforms, the game provider must provide different game versions. As a result, the following problems may happen.

(1) If the key is leaked, person getting the key and the encryption can access to the game interface directly.

(2) The game provider must provide different game versions for different platforms, which increases development and operation costs.

The reason for generating the problems above is that, the operation server verifies the external platform directly, namely the external platform may access the operation server directly.

So far a solution for solving the problems mentioned above is not provided.

### SUMMARY

The present disclosure provides a validity verification method and an intermediate server, to reduce problems caused by the operation server verifying the external platform directly.

According to one aspect of the present disclosure, a validity verification method includes: receiving, by an intermediate server, a request from one or more external platforms for accessing an operation server; connecting, by the intermediate server, the one or more external platforms with the operation server; verifying, by the intermediate server, validity of the request according to an external platform and an operation which the external platform is one of the one or more external platforms and identifies where the request is from, and the operation is requested to be accessed by the external platform; and after the request is verified, sending, by the intermediate server, the request to the operation server.

According to another aspect of the present disclosure, an intermediate server, includes: memory; one or more processors; a receiving the module having memory and the one or more processors, arranged for receiving a request from one or more external platforms for accessing an operation server wherein the intermediate server connects the one or more external platforms with the operation server; a verification module having memory and the one or more processors, arranged for verifying validity of the request according to an external platform and an operation which the external platform is one of the one or more external platforms and identifies where the request is from and the operation is requested to be accessed by the external platform; and a sending module having memory and the one or more processors, arranged for sending the request to the operation server, after the request is verified.

By this way, the request from one or more external platforms for accessing the operation server is received by the intermediate server, and the intermediate server is connected the one or more external platforms with one or more operation servers. And then the request is verified by the intermediate server according to the external platform where the request is from and an operation requested to be accessed, and finally sent to the corresponding operation server if the request is valid. As such, the problem caused by the operation server directly verifying the external platform can be solved, and in turn, a safe and reliable joint management can be achieved.

### BRIEF DESCRIPTION OF THE DRAWINGS

To explain the technical solutions of the embodiments of the present disclosure, accompanying drawings used in the embodiments are followed. Apparently, the following drawings merely illustrate some embodiments of the disclosure, but for persons skilled in the art, other drawings can be obtained without creative works according to these drawings.

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a flowchart of a validity verification method according to one example of the present disclosure;

FIG. 2 is a block diagram of an intermediate server according to one example of the present disclosure;

FIG. 3 is a schematic view for operation basic information configuration according to an example of the present disclosure;

FIG. 4 is a schematic view of a joint-management interactive system according to an example of the present disclosure; and

FIG. 5 is a schematic view of a joint-management security interactive server according to an example of the present disclosure.

### DETAILED DESCRIPTION

The principles described herein may be embodied in many different forms. Not all of the depicted components may be required, however, and some implementations may include additional components. Variations in the arrangement and type of the components may be made without departing from the spirit or scope of the claims as set forth herein. Additional, different or fewer components may be provided.

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The exemplary environment may include a server, a client, and a communication network. The server and the client may be coupled through the communication network for information exchange, such as sending/receiving identification information, sending/receiving data files such as splash screen images, etc. Although only one client and one server are shown in the environment, any number of terminals or servers may be included, and other devices may also be included.

The communication network may include any appropriate type of communication network for providing network connections to the server and client or among multiple servers or clients. For example, communication network may include the Internet or other types of computer networks or telecommunication networks, either wired or wireless. In a certain embodiment, the disclosed methods and apparatus may be implemented, for example, in a wireless network that includes at least one client.

In some cases, the client may refer to any appropriate user terminal with certain computing capabilities, such as a personal computer (PC), a work station computer, a server computer, a hand-held computing device (tablet), a smart phone or mobile phone, or any other user-side computing device. In various embodiments, the client may include a network access device. The client can be stationary or mobile.

A server, as used herein, may refer to one or more server computers configured to provide certain server functionalities, such as database management and search engines. A server may also include one or more processors to execute computer programs in parallel.

It should be noticed that, the embodiments and the features in the embodiments can be combined with each other in a no conflict condition. This disclosure will become apparent from the following detailed description when taken in conjunction with the accompanying drawings.

It should be noticed that, the steps illustrated in the flowchart of the drawings can be performed in a set of computer device with executable program codes. And the order of the steps can be different from that in the drawings under some status, although a logic order is shown in the flowchart.

In the following description, one or more denotations of actions or operations performed by the computer will be used to show the present disclosure, unless a special demonstration is pointed out. Concretely, the computer can be a personal computer, a server, or a mobile terminal, etc., and the device with processing chips such as CPU, Single Chip Micyoco, and DSP is also called a computer. It should be understood that, the actions and operations performed by the computer include manipulations to electrical signals for the process unit in the computer. The manipulations convert the data and its position in the storage device of the computer, which is understood by the persons skilled in the art. Data structure of the maintenance data has its physical position in the storage with special attribute. However, there is no limitation in this disclosure. As understood by persons skilled in the art, the actions and operations described thereinafter can be complemented by hardware.

Turning to the drawings, the same reference numeral indicates the same element, the principle of the disclosure could be achieved in a suitable computer condition. The following description is based on the embodiments of the present disclosure, which is not limited to some replacement embodiments failed to be mentioned in the disclosure however.

Preferably, the present embodiments in the disclosure can provide a machine-readable medium with embodiments stored therein. It should be noticed that, any one suitable medium related to the commands of the disclosure is within the scope of the disclosure, such as magnetic media, optical media, or semiconductor media.

In the following embodiments, the intermediate server can be one or a set, which is connected with the external platforms and the operation servers. The operation servers also can be one or more. The one or more operation servers can run one operation, at this time, multiple external platforms access the operation via the intermediate server. One or a set of operation servers can run several operations, at this time, the one or more external platform can access one or more operations run in the operation servers via the intermediate server. Different external platforms have different purviews. After the intermediate server receives a request from the external platform, the request will be verified according to the external platform and the operation to be accessed.

It should be noticed that, the title of the intermediate server is just used to be facilitated description. Any one or a set of servers acted the same function with that in the present embodiment could be called as intermediate servers. Thus the title of intermediate server should not limit the present disclosure.

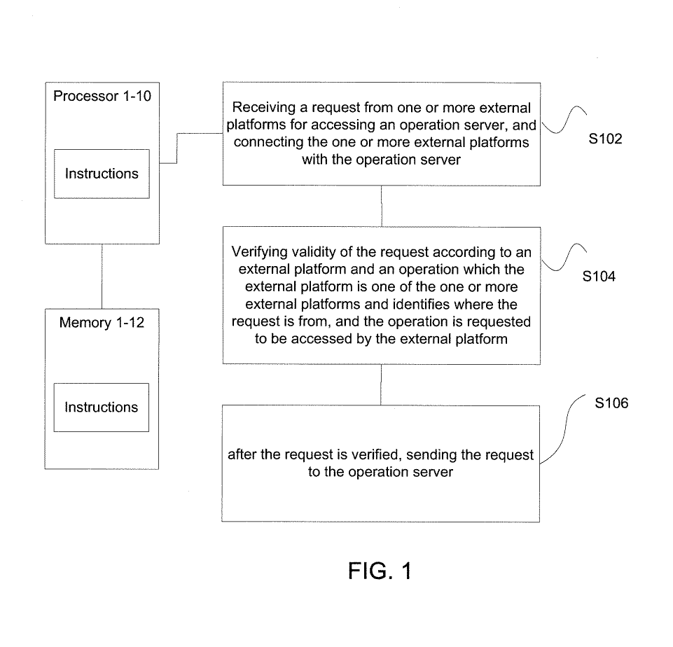

In the present embodiment, a validity verification method is provided. FIG. 1 is a flowchart of a validity verification method according to one embodiment of the present disclosure. As shown, the method includes the following steps.

Step 102 shows the step of receiving, by an intermediate server, a request from one or more external platforms for accessing an operation server; and connecting, by the intermediate server, the one or more external platforms with the operation server

Step 104 illustrates the step of verifying, by the intermediate server, validity of the request according to an external platform and an operation wherein the external platform is one of the one or more external platforms and identifies where the request is from, and the operation is requested to be accessed by the external platform.

Step 106 shows that after the request is verified, sending, by the intermediate server, the request to the operation server.

In such a way, an intermediate server is added between the external platform and the operation server, by which the request for accessing the operation server is received by the intermediate server, and then verified by the intermediate server, and finally sent to the corresponding operation server if the request is valid. Since the intermediate server is added, thus the operation server will not directly verify the external platform any longer, thereby the problem caused by the operation server directly verifying the external platform can be solved, and in turn, a safe and reliable joint management can be achieved.

For example, a game is an operation, and a game server is an operation server. Regarding the problems pointed out in the background:

(1) If the key is leaked, person getting the key and the encryption can access to the game interface directly.

(2) The game provider must provide different game versions for different platforms, which increases development and operation costs.

The problem (1) can be prevented in this example. Since the validity verification is performed by the intermediate server according to the external platform, therefore, even if the key is leaked, the person having the key can't access to the game.

As to the problem (2), since the verification function is carried by the intermediate server, various external platforms can be verified by the intermediate server, the game provider does not need to provide different game versions to different platforms. As a result, multiple game versions may not be needed, development costs and operation costs are thus reduced.

There are many ways for verifying validity of the request, in this example, several preferable methods for verifying validity of the request are provided, including request link verification, request identity verification, big zone verification, and authorized function verification which can be used separately or jointly. Following is the detailed descriptions of these verifications.

Request Link Verification

The request link verification is used for verifying attributes of the request, and the attributes at least includes access time, parameter validity, timestamp verification, or access frequency, etc. Following is a detailed explanation to the request link verification.

The access time verification is used for determining if the request is made when the operation starts, if yes, the request is valid; otherwise is invalid.

The parameter validity verification is used for determining if a parameter carried in the request and to be sent to the operation meets an operation requirement, if yes, the request is valid; otherwise is invalid. The operation requirement may be pre-determined or later developed.

The timestamp verification is used for determining if the request is timeout according to whether a timestamp carried in the request exceeds a preset timeout period, if yes, the request is invalid; otherwise is valid.

The access frequency verification is used for determining if accessing time for accessing the operation in a preset period is greater than a threshold value, if yes, the request is invalid; otherwise is valid.

Based on the request link verification mentioned above, it can prevent the game data in other external platforms being accessed by the external platform via parameters traversal attempt. Meanwhile, it can prevent problems of incapable to handle with malicious behavior of the cooperation party, such as burden caused by frequent access or malicious access to the game, or obtaining sensitive data via the opened interface.

Request Identity Verification

The request identity verification is used for verifying the origin of the request. The origin of the request can include MD5 verification, Network protocol IP address, etc. This verification is illustrated as follows:

The MD5 algorithm (message digest algorithm 5) verification is used for verifying integrality of the request, if the verification is correct, the request is valid; otherwise is invalid.

The network protocol IP address verification is used for determining if an IP address of the external platform is listed in a preset list such as white list, if yes, the request is valid; otherwise is invalid.

Big Zone Verification

If there are several operation severs, then different external platforms are distributed with different operation servers, as a result, only the distributed operation servers will be accessed by the external platform correspondingly. As such, the operation servers may be divided into big zones to serve external platforms. For example, there are six operation servers, therein the first and the second operation servers are allowable to be accessed by an external platform of party A, the third and the fourth operation servers are allowable to be accessed by an external platform of party B, and the fifth and sixth operation servers are allowable to be accessed by an external platform of party C.

Or, the operation servers can be divided according to geographic area. For example, the external platform of party A can access the operation servers in the north of China, the external platform of party B can access the operation servers in the center of China, and the external platform of party C can access the operation servers in the south of China. The area where the operation servers are located can be pre-configured, or determined by the IP address.

For the big zone verification, the intermediate server will determine if the external platform where the request is from is in a list of operation servers of a big zone. The determination is that, the intermediate server determines if the operation server to be requested to access is an operation server that authorizes to the external platform where the request is from, if yes, then the request is valid; otherwise, the request is invalid. Concretely, the intermediate server stores a list of operation servers which authorize the external platforms.

Based on the big zone verification, the operation servers can be divided logically, thereby the source of the operation servers can be assigned legally.

Authorized Function Verification

For different external platforms, functions allowed to be used are different. Thus, the authorized function verification is used for verifying if the function to be requested is allowable. At this time, the intermediate server will determine if the function to be accessed is allowable to be accessed by the external platform, if yes, then the request is valid; otherwise is invalid. Concretely, the intermediate server stores a corresponding relationship between the external platforms and the functions allowing the external platforms to access.

In the present embodiment, it should be noticed that, the four methods for verifying validity of the request can be performed individually or jointly together, and there is no order for the performing. Preferably, the intermediate server verifies the request by performing the request link verification, the request identity verification, the big zone verification, and the authorized function verification in order.

In the example, the intermediate server can store purview information of the external platform in a form of configuration files, namely, according to identifications of the operation to be accessed and identifications of the external platform, the intermediate server can obtain the configuration files corresponding to the identification information, and then verify the validity of the request according to the configuration files.

The steps disclosed in FIG. 1 may be performed by one or more processors 1-10 that are coupled with memory 1-12. Instructions to be executed to perform above steps may be stored in memory 1-10 and executed by the one or more processors 1-10.

Furthermore, the present disclosure provides another example of an intermediate server that is used in the methods mentioned above. Explanation mentioned in the above examples will not be repeated in following disclosure.

It should be noticed that, the title of the modules in the servers mentioned thereinafter is not a limitation to the modules. For example, a receiving module can be described as “a module for receiving a request from one or more external platforms for accessing an operation server”. The modules mentioned below can be performed in processors that are coupled with memory, for example, the receiving module can be described as “a processor, for receiving a request from one or more external platforms for accessing an operation server”, or “a processor having memory, including a receiving module”, etc.

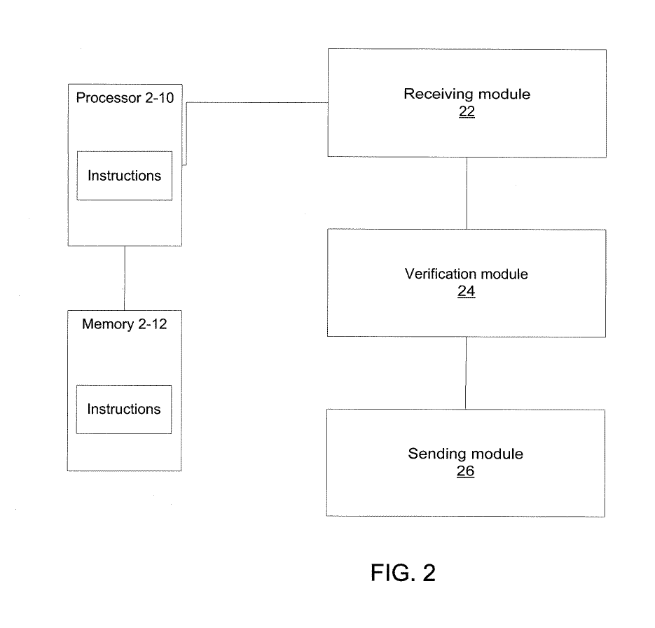

FIG. 2 is a block diagram of an intermediate server according to one embodiment of the present disclosure. As shown, the server includes a receiving module 22, a verification module 24, and a sending module 26. The receiving module 22, the verification module 24 and the sending module 26 may be performed by one or more processors 2-10 that are coupled with memory 2-12. Instructions to be executed by the modules may be stored in memory 2-10 and executed by the one or more processors 2-10. Following is the detailed description.

Specifically, the receiving module 22 is arranged for receiving a request from one or more external platforms for accessing an operation server; and the intermediate server connecting the one or more external platforms with one or more operation servers.

The verification module 24 is arranged for verifying validity of the request according to the external platform where the request is from and an operation requested to be accessed.

The sending module 26 is arranged for sending the request to the corresponding operation server, after verifying the request is valid.

In such a way, an intermediate server is added between the external platform and the operation server, by which the request for accessing the operation server is received by the intermediate server, and then verified by the intermediate server, and finally sent to the corresponding operation server if the request is valid. Since the intermediate server is added, thus the operation server will not directly verify the external platform any longer, thereby the problem caused by the operation server directly verifying the external platform can be solved, and in turn, a safe and reliable joint management can be achieved.

In this example, the verification module 24 is arranged for performing a request link verification for verifying attributes of the request, a request identity verification for verifying origin of the request, a big zone verification for verifying the operation server allowed to be accessed by the external platform, and an authorized function verification for verifying if a function to be requested is allowable.

In this embodiment, the request link verification performed by the verification module 26 may include the following processes:

Access time verification, for determining if the request is made when the operation starts, if yes, the request is valid; otherwise is invalid.

Parameter validity verification, for determining if a parameter carried in the request and to be sent to the operation meets an operation requirement, if yes, the request is valid; otherwise is invalid. The operation requirement may vary. However, the operation requirement does require one or more parameters carried in the request satisfy certain condition or conditions.

Timestamp verification, for determining if the request is timeout according to whether a timestamp carried in the request exceeds a preset timeout period, if yes, the request is invalid; otherwise is valid.

Access frequency verification, for determining if the number of times to access the operation in a preset period is great than a threshold value, if yes, the request is invalid; otherwise is valid.

The request identity verification performed by the verification module 24 may includes:

MD5 algorithm (message digest algorithm 5) verification, for verifying integrality of the request, if the verification is passed, the request is valid; otherwise is invalid; and

Network protocol IP address verification, for determining if an IP address of the external platform is listed in a preset list such as a white list, if yes, the request is valid; otherwise is invalid.

In this example, the big zone verification performed by the verification module may include the following process.

The verification module 24 is arranged for determining the operation server to be request to access is an operation server that authorizes the external platform where the request is from, if yes, the request is valid; otherwise is invalid. The intermediate server stores a list of operation servers that authorize the external platforms.

The authorized function verification performed by the verification module 24 may include the following process:

The verification module 24 is arranged for determining if a function to be requested to access is allowable to be accessed by the external platform, if yes, the request is valid; otherwise is invalid. The intermediate server stores a corresponding relationship between the external platforms and the functions to be accessed.

In the present example, it should be noticed that, the four verifications for verifying validity of the request can be performed individually or jointly together, and there is no order for the performing. Preferably, the intermediate server verifies the request by performing the request link verification, the request identity verification, the big zone verification, and the authorized function verification in order.

Furthermore, the verification module is arrange for, according to identifications of the operation and identifications of the external platform, obtaining configuration files corresponding to the identifications, and verifying validity of the request according to the configuration files.

The operations managed by the operation server may vary, following is a detailed explanation with an example of a game serving as the operation:

In the preferable example, a joint management security interactive system (equivalent to the intermediate server mentioned above) is mainly applicable to ensure security between an external joint-management platform (equivalent to the external platform mentioned above) and a joint-management Web game server (equivalent to the operation server mentioned above) that is coupled with game data interaction. All games (mainly Web game) may achieve the security while carrying out an external join management by merely connecting to the joint-management security system.

When the operation is accessed by the joint-management platform, the operation accessed will be allocated a unique operation ID, and a basic configuration is generated to produce a special configuration file. When a request to access is placed, the security system will search out the corresponding configuration file according to the operation ID, to verify the validity of the request.

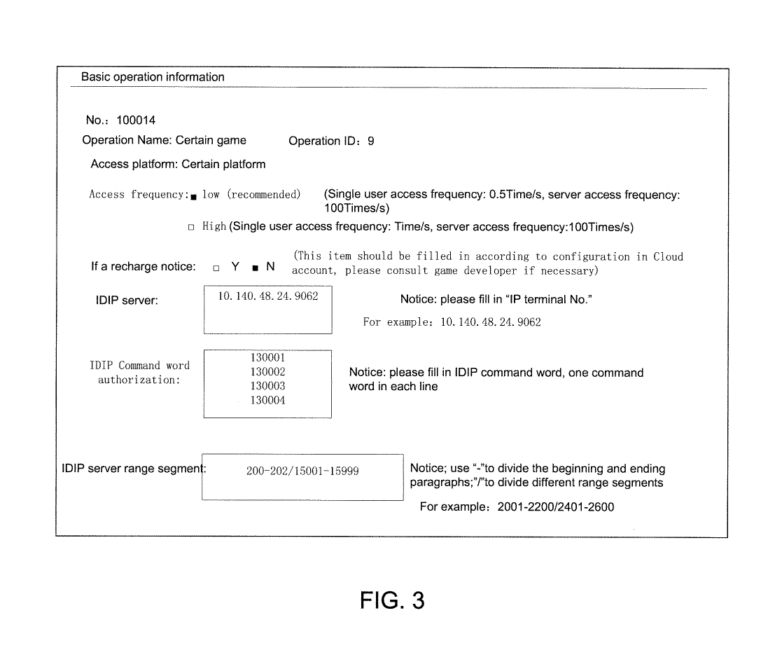

FIG. 3 is a schematic view of basic information configuration for the operation according to a preferable example of the present disclosure. As shown, a certain operation of Web version is accessing to a certain platform, and the only operation ID: 9 is allocated. And some basic configurations such as access frequency, a notice for reminding a recharge, IDIP server, IDIP command word authorization, IDIP server range segment are also filled in. The basic information configuration files generated are as follows:

[FRAMEWORK DEFAULT]
#Opening time of the system
dtBeginTime=2010-01-10 10:00:00
dtEndTime=2999-07-20 24:00:00
tOpenTime=00:00:00
tcloseTime=00:00:00
#Limition of access frequency for user
iIndividualCtrlSec=2
iIndividualCtrlTime=1
iWholeCtrlSec=1
iWholeCtrlTime=100
# Login state failure time, unit is second
Expeiretime=300
#If a separate account database, false means No
IsUinTransfer=0
#Returns encoding format in Chinese, default is: utf8+urlencode
codeType= utf8+urlencode
#idip Authorized scope of server
IDIPServer=200-202/15001-15999
# Signature verification
[sign]
#If the signature with a parameter name
isSignWithName=false
#If the signature converts to capitalization
isSignWithName=true
#ip White list
[iplist]
check=true
ip0=14.17.22.20
ip1=121.9.221.137
ip2=119.147.163.133
ip3=113.108.228.123
ip4=222.73.61.88

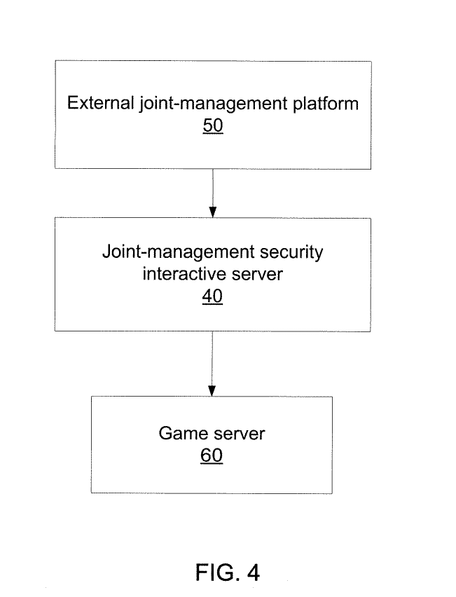

FIG. 4 is a schematic view of a joint-management interactive system according to a preferable example of the present disclosure. As shown, the system includes a joint-management security interactive server 40, an external joint-management platform 50, and a game server 60.

The joint-management interactive system 40 is mainly applicable to ensure security of the data interacted between the external joint-management platform 50 and the game server 60. When game are operated, the external joint-management platform 50 and the game server 60 are accessed via the joint-management security interactive server 40. As such, a safe external join management may be achieved.

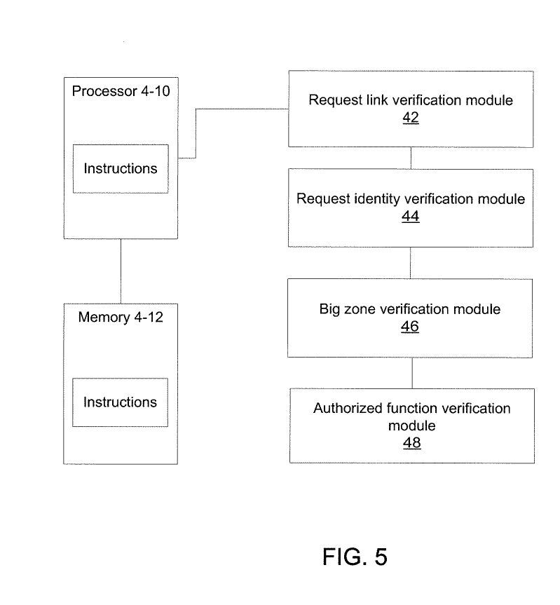

FIG. 5 is a schematic view of a joint-management security interactive server according to another preferable example of the present disclosure. As shown, the joint-management security interactive server 40 includes four modules as following: a request link verification module 42, a request identity verification module 44, a big zone verification module 46, and an authorized function verification module 48. All four modules may be performed by one or more processors 4-10 that are coupled with memory 4-12. Instructions to be executed by the modules may be stored in memory 4-10 and executed by the one or more processors 4-10.

Following is a description of the joint-management security interactive server 40.

1. Request Link Verification Module 42.

The request link verification module 42 may perform the access time verification, the access frequency verification, the parameter validity verification and the timestamp verification.

(1) Access time verification, which determines if the request is made when the operation starts according to the configuration files.

(2) Parameter validity verification, which verifies the parameter sent by the cooperation party, the request is denied if the parameter does not meet an operation requirement.

(3) Timestamp verification, which compares the timestamp of the parameter in the cooperation party with the current event, the request will be refused if the timestamp of the parameter exceeds a preset timeout period.

(4) Access frequency verification, which the access frequency can be set for a single user or server.

2. Request Identity Verification Module 44

The request identity verification module 44 may include MD5 verification, and IP white list.

(1) MD5 Verification

MD5 is a hash function, which is a one-way operation for converting a data string with any length to a short value with a constant length, and any two strings should not have the same hashing value.

MD5 verifies validity of the data by hashing the transmission data received. The hashing value calculated will be compared with a hashing value transferring along with the data, the transmission data will be considered to be correct without falsified, if the two values are the same.

In the present example, hashing is performed to the request for the game data to verify the validity of the data. The hashing value calculated by the request identity verification module 44 is compared with a hashing value transferring along with the game data, the transmission data will be considered to be correct without falsified, if the two values are the same. That is, the identity verification of the request passes.

Every request for the game data must be verified by MD5.

(2) IP White List

For each external joint-management platform 50, the cooperation party is required to supply IP addresses for all servers it allows and make a record for these addresses. And then an IP list for the record will be produced. Concretely, the IP white list includes IP address and IP address segment. The request identity verification module 44 will determine if the external platform is a cooperated external platform according to the IP address and IP address segment of the IP white list, if no, the identity verification would not be passed.

3. Big Zone Verification Module 46

To prevent configuring each external joint-management platform 50 with a set of game interfaces, different big zone segments are allocated to different external joint-management platforms 50 when they are under joint management. However, this may cause different cooperation parties possibly access data in other platforms by a big zone number. Thus, a big zone verification must be performed so as to prevent a cross-access in different platforms.

The verification of the big zone verification module 46 is as follows:

(1) Searching out a configuration file corresponding the operation, according to the only operation ID sent by the external joint-management platform 50.

(2) Determining if the current server accessed is a server authorized by the external joint-management platform 50, according to the configuration item of the IDIP server.

(3) Performing security verification for the modules after validating the big zone is authorized, otherwise refusing the request.

4. Authorized Function Verification Module 48

After validating the validity of the request, then purview verification to the function to be request is performed. Three levels are included according to the sensitivity of the interfaces:

(1) The third level has basic functions with low sensitivity which are necessary for a game's normal operation, such as login, role inquiry, or online status, etc. The functions in this level will not be performed an authorization verification.

(2) The second level has some functions affecting the game data which are necessary for the game operation, such as recharge, account closing, objects providing, etc. The functions in this level are carried out by calling IDIP command. The specific authorized functions are determined by the external joint-management platform 50 and the game server 60, the IDIP command is configured when the functions are accessed. When a request is received, the current using command word will be determined if it is the authorized command word.

(3) The first level relates to the function with sensitive data, for example obtaining operation analysis data such as recharging data, online data, etc., which have high sensitivity. Interfaces for these functions are individual and separated, and they have their respective MD5 key and encrypt. While using, configuration files for the interfaces will be generated respectively in a unit of operation ID. Such functions are independently used, and an isolated authorization is carried out to the function use at physical level.

Based on security process of the joint-management security interactive server 40, the game may maintain only one game version. Since different big zones are allocated to different external platforms for using, thus game side will not need to focus on the security of accessing any longer, all unsafe or unnecessary accessing will be denied to reach the game server.

Based on the preferable example described above, the game provider only needs to configure a set of game interfaces, and a safe and reliable joint management can be performed on multiple platforms. Some game developments such as security development, special interface maintenance or security verification are not needed. Therefore, through the use of the joint-management security interactive system, only one set of game logics is needed to perform a safe and reliable, multi-level, multi-dimensional joint management on multiple external platforms.

The examples described above can be combined to use. In addition, terms such as “module” or “unit” used in this disclosure can indicate software objects or routines performed on the devices mentioned above. Different modules and units described here can be objects or processes performed on the devices mentioned above (for example, as a separated thread). Meanwhile, it's possible and constructed when the device mentioned above is used as a combination of hardware and software, hardware and hardware.

Apparently, persons skilled in the art should understand, the modules or steps in the present disclosure can be implemented by a common computer device, they can be integrated in a single computer device, or arranged in a network composed of several computer devices. Optionally, they can be implemented by executable program codes of a computer device, so that they can be stored in storage device to be performed by the computer device, or they can be made as individual integrative circuit modules, or as a single integrative circuit module. Thereby the present disclosure is not limited to any combination of specific software of hardware.

While the disclosure has been described in connection with what are presently considered to be the most practical and preferred examples and/or embodiments, it is to be understood that the disclosure is not to be limited to the disclosed examples and embodiments, but on the contrary, is intended to cover various modifications and equivalent arrangements included within the spirit and scope of the disclosure and this disclosure.

What is claimed is:

1. A validity verification method, comprising:
receiving, by an intermediate server, a request from one or more external platforms for accessing an operation server;
connecting, by the intermediate server, the one or more external platforms with the operation server;
verifying, by the intermediate server, the validity of the request according to an external platform and an operation, wherein the external platform is one of the one or more external platforms and identifies where the request is from, and the operation is requested to be accessed by the external platform; and
after the request is verified, sending, by the intermediate server, the request to the operation server.

2. The method according to claim 1, wherein the verifying the validity of the request further comprises at least one of:
verifying a request link;
verifying a request identity;
verifying a big zone;
verifying an authorized function; and
wherein the verifying the request link is to verify attributes of the request, the verifying the request identity is to verify an origin of the request, the verifying the big zone is to verify the operation server allowed to be accessed by the external platform, and the verifying the authorized function if to verify if a function to be requested is allowable.

3. The method according to claim 2, wherein the verifying the request link further comprises at least one of:
verifying access time to determine if the request is made before the operation starts, if yes, the request is valid; otherwise is invalid;
verifying parameter validity to determine if a parameter carried in the request and to be sent to the operation meets an operation requirement, if yes, the request is valid; otherwise is invalid;
verifying a timestamp to determine if the request is timeout according to whether the timestamp carried in the request exceeds a preset timeout period, if yes, the request is invalid; otherwise is valid; and
verifying access frequency to determine if a number of times to access the operation in a preset period is greater than a threshold value, if yes, the request is invalid; otherwise is valid.

4. The method according to claim 2, wherein the verifying the request identity further comprises at least one of:
verifying a MD5 algorithm (message digest algorithm 5) to verify integrality of the request, if the verification is passed, the request is valid; otherwise is invalid; and
verifying a network protocol IP address to determine if the network protocol IP address of the external platform is listed in a preset list, if yes, the request is valid; otherwise is invalid.

5. The method according to claim 2, wherein the verifying the big zone further comprises:
determining, by the intermediate server, whether the operation server to be request to access authorizes the external platform, if yes, the request is valid; otherwise is invalid; and storing, by the intermediate server, a list of operation servers that authorizes the external platform.

6. The method according to claim 2, wherein the verifying the authorized function further comprises:
determining, by the intermediate server, if the function to be requested to access is allowable to be accessed by the external platform, if yes, the request is valid; otherwise is invalid; and storing, by the intermediate server, a relationship between the external platform and the function to be accessed.

7. The method according to claim 2, wherein the verifying the validity of the request further comprises:
verifying, by the intermediate server, the request link, the request identity, the big zone, and the authorized function in order.

8. The method according to claim 1, wherein the verifying the validity of the request further comprises:
according to an identification of the operation and an identification of the external platform, obtaining, by the intermediate server, configuration files corresponding to the identifications; and
verifying, by the intermediate server, the validity of the request according to the configuration files.

9. An intermediate server, comprising:
memory;
one or more processors; and
a receiving the module having memory and the one or more processors, arranged for receiving a request from one or more external platforms for accessing an operation server wherein the intermediate server connects the one or more external platforms with the operation server;
a verification module having memory and the one or more processors, arranged for verifying validity of the request according to an external platform and an operation wherein the external platform is one of the one or more external platforms and identifies where the request is from and the operation is requested to be accessed by the external platform; and
a sending module having memory and the one or more processors, arranged for sending the request to the operation server, after the request is verified.

10. The intermediate sever according to claim 9, wherein the verification module having memory and the one or more processors comprises at least one of:
a request link verification module;
a request identity verification module;
a big zone verification module;
an authorized function verification module; and
wherein the request link verification module having memory and the more or more processors is to verify attributes of the request, the request identity verification module having memory and the more or more processors is to verify an origin of the request, the big zone verification module having memory and the one or more processors is to verify the operation server allowed to be accessed by the external platform, and the authorized function verification module having memory and the one or more processors if to verify if a function to be requested is allowable.

11. The intermediate sever according to claim 10, wherein the request link verification module having memory and the one or more processors comprises at least one of following functions to:
verify access time to determine if the request is made before the operation starts, if yes, the request is valid; otherwise is invalid;
verify parameter validity to determine if a parameter carried in the request and to be sent to the operation meets an operation requirement, if yes, the request is valid; otherwise is invalid;
verify a timestamp to determine if the request is timeout according to whether the timestamp carried in the request exceeds a preset timeout period, if yes, the request is invalid; otherwise is valid; and
verify access frequency to determine if a number of times to access the operation in a preset period is greater than a threshold value, if yes, the request is invalid; otherwise is valid.

12. The intermediate sever according to claim 10, wherein the request identity verification module having memory and the one or more processors comprises at least one of following functions to:
verify a MD5 algorithm (message digest algorithm 5) to verify integrality of the request, if the verification is passed, the request is valid; otherwise is invalid; and
verify a network protocol IP address to determine if the network protocol IP address of the external platform is listed in a preset list, if yes, the request is valid; otherwise is invalid.

13. The intermediate sever according to claim 10, wherein the big zone verification module having memory and the one or more processors is to:
determine, by the intermediate server, whether the operation server to be request to access authorizes the external platform, if yes, the request is valid; otherwise is invalid; and store, by the intermediate server, a list of operation servers that authorizes the external platform.

14. The intermediate sever according to claim 10, wherein the authorized function verification module is to:
determine, by the intermediate server, if the function to be requested to access is allowable to be accessed by the external platform, if yes, the request is valid; otherwise is invalid; and store, by the intermediate server, a relationship between the external platform and the function to be accessed.

15. The intermediate sever according to claim 10, wherein the verification module is arranged to verify the request link, verify the request identity, verify the big zone, and verify the authorized function in order.

16. The intermediate sever according to claim 10, wherein the verification module is arranged to, according to an identification of the operation and an identification of the external platform, obtain, by the intermediate sever, configuration files corresponding to the identifications, and verify, by intermediate sever, the validity of the request according to the configuration files.
